(19) United States
(12) Patent Application Publication
(10) Pub. No.: US 2005/0272414 A1
(43) Pub. Date: Dec. 8, 2005

(54) Communication and telephone assistance system

(76) Inventor: Jorge Marcelo Vallarino, Mendoza (AR)

Correspondence Address: Stephan A. Pendorf;Pendorf & Cutliff, 5111 Memorial Highway, Tampa, FL, 33634-7356, US

(21) Appl. No.: 11/029,681

(22) Filed: Jan. 5, 2005

(30) Foreign Application Priority Data
Jun. 2, 2004 (AR) P040101899

(51) Int. Cl. H04M 11/04

(52) U.S. Cl. 455/417

(57) ABSTRACT

The present invention concerns a communication and telephonic assistance system, by which the user can be assisted in his own language. The system includes translation services, interpretation services online, and/or tourism information related to the country being visited.

### FIELD OF THE INVENTION

This invention relates to a communication and telephone assistance system, preferably to cellular, and tourism applications, to be implemented by telecommunications technology.

### DESCRIPTION OF PRIOR ART

It is known by all, the complications generated when one is visiting a foreign country where the language used is not our native language, furthermore, it is totally incomprehensible due to the total lack of similarities in the language.

Furthermore, considering the necessity of contacting a particular telephone number, such as a credit card company, or a health care organization, or an embassy or consulate, or the likes, one would have to use a phone book, or call a telephone number of our country of origin, we need to use the services of the local public telephone service at the country where we are.

It is even a more complex situation when one would like to visit tourist sites, or when one would like to move in a city where everything is new, where maybe even the alphabet of the foreign language it not the same as one's own language, and wherein we do not know who to trust, or if the information being provided is accurate.

All these complications, without doubt, predisposition the person's decision regarding the place to go for vacations, in view that the vacation is our resting time and reward for a full year of work.

Another inconvenience found in countries where the language is different, is to understand the street or traffic signs on public roads. This frequently generates traffic accidents, if we rent a transportation medium and drive on roads in this country without totally understanding the street and traffic signs.

It is also known, that at the time of going shopping, the language barrier will limit these purchases, because of the complication generated when requesting additional items, different color or size, limiting one to purchase only what we see, and not really what we are looking for.

With the present invention, the person will have a general assistant, which would speak our own language, and would have a complete understanding of the country being visited.

In reference to the closest prior art, one could find the traveler assistance centers offered by airlines, but these are limited to provide information related to air transportation. Also in this group, there are known different customer service centers, each one for a specific service, where no centralized customer service exists; forcing the customer to utilize several different telephone numbers, frequently not available.

The present invention provides a solution to each problem discussed above, by using a direct communication medium with an integral tourist service center, which will offer personal translation services, and online translation services, responding to any question the tourist may have related to the country being visited, or connecting the user to the person or organization that the user have requires to contact.

These characteristics will be enhanced by using cellular telephones, which would be provided to the user as they arrive to the country.

These cellular telephones could be rented, or sold to the user (tourists), and the service can be available for immediate use to any cellular telephone from such country, for a prepaid fee, or by charging a credit card for each use.

In addition, as each tourist is related to a particular cellular telephone, the service center can continuously send messages, and more particularly in text format, related to tourism sites of interest, advertisement for trips through such country, city tours, places for shopping for crafts, places for shopping typical things, etc.

Still another embodiment of the present invention is to allow the user to choose the type of information which the service center (call center) will provide. That is, if the user only wishes to receive information related to (for example) “Buenos Aires Music,” the call center will not send any information other than that information which is chosen by the user.

The user of the cellular telephone will be assisted in the user's own language, and assisted in any aspect related to the language of such country, as well as any type of tourism information. As previously indicated, the user can be connected to any organization in the country, or outside the country, which we need to communicate.

The cellular phone used to offer this service, will also serve as communication media with friends or family from the user's original country.

Furthermore, considering the situation were the user places a call in the country being visited, for example to make a restaurant reservation; the telephone call will be rated with the local rates, as opposed to the rates associated to using his own cellular telephone, as these rates probably would be an international telephone call (international roaming).

### DESCRIPTION OF THE INVENTION

In accordance with the previous paragraphs, it is the main object of the present invention to provide a system for communication and telephonic assistance, by which the user can be assisted in his own language, with translation services, interpretation services online, and/or tourism information related to the country being visited.

It is also an object of this invention to provide a cellular telephone which will have several telephone numbers for accessing various customer service centers, each one for a particular country.

For example, if the tourist is visiting Europe, the tourist will have a cellular telephone with various assistance telephone numbers, each one of them will connect the directly the tourist customer service center, for example, Spain, Italy, Germany, Holland, France, as well as any other country to be visited.

The interested tourist can either contract this service at the tourist original country, receiving the cellular telephone which would allow the tourist to access these important services, or the tourist can contract this service from the airline providing transportation to the country to be visited.

As an additional detail, the call from the cellular telephone to the tourist service center would be free of charge, such that any question the user may have would be processed without billing complications to the user.

Providing additional details related to the functionality of the system proposed herein, the communication between the user and the call center will only occur after the user accepts the terms of this service, and the different type of information the call center personnel will offer in the user's/tourist's original language.

It is understood that the assistance provided by such call center to the tourist will be personal, and that employees working at the call center will be trained and willing to speak with a third party, always through the tourist communication device, in order to solve the lack of understanding between such third party and the tourist, in view of the different native language.

It should not be discarded that the present communication system will also be valid even from public telephones, that is, if the user looses the cellular telephone, and requires immediate assistance, the user can continue using this service from any telephone.

Without any doubt, accessing this system from an external telephone, that is, other than the cellular telephone provider, will require entering security codes, similar to those used by other telephone services which require access codes.

There are many additional services which the present invention could provide. The user will only have to purchase the products and/or services being offered, and the call center will be responsible for closing the deal in the user's name.

Considering the emerging telecommunication technologies, it will be possible to pinpoint the location of the user through the user's cellular telephone, and for example, offer the user the needed information to go to the place he or she whishes.

It is also understandable that cellular telephone services available today will also work if the user of the present invention makes use of them.

Having carefully explained the nature of the present invention, and the way to put into practice this invention, it is being declared as an exclusive right and property the following claims:

1-7. (canceled)

8. A communication and telephonic assistance system for tourist assistance applications comprising:
a communication, after previously dialing a specific telephone number, between a communication device in possession of the tourist and a receiving tourist information call center,
wherein a personnel of the tourist information call center:
responds to the tourist in his own native language,
assists the tourist on language consultations from the country being visited, or
provides the tourist with information related to the country being visited.

9. A communication and telephonic assistance system, according to claim 8, wherein the communication device is a cellular telephone.

10. A communication and telephonic assistance system, according to claim 8, wherein the communication device is a public telephone.

11. A communication and telephonic assistance system, according to claim 8, wherein the call center generates information text messages which are sent to the tourist's communication device.

12. A communication and telephonic assistance system, according to claim 8, wherein the communication between the communication device and the call center is unlimited and free of charges.

13. A communication and telephonic assistance system, according to claim 8, wherein the personnel at the call center are trained and willing to speak with a third party through the tourist communication device, in order to solve the lack of understanding between the third party and the tourist, since neither knows each others native language.

14. A communication and telephonic assistance system, according to claim 8, wherein the call center is able to connect the tourist communication device with a telephone number to which the user needs to contact.
